(19) United States
(12) Patent Application Publication
(10) Pub. No.: US 2007/0116393 A1
(43) Pub. Date: May 24, 2007

(54) Needle roller bearing, crank shaft supporting structure, and split method of outer ring of needle roller bearing

(76) Inventors: Shinji Oishi, Iwata-shi (JP); Makoto Nishikawa, Iwata-shi (JP); Akihiko Katayama, Iwata-shi (JP); Takanori Terada, Iwata-shi (JP); Takaaki Sakai, Iwata-shi (JP); Katsufumi Abe, Iwata-shi (JP); Masaaki Okagawa, Iwata-shi (JP)

Correspondence Address: CLARK & BRODY, 1090 VERMONT AVENUE, NW, SUITE 250, WASHINGTON, DC, 20005, US

(21) Appl. No.: 11/600,802

(22) Filed: Nov. 17, 2006

(30) Foreign Application Priority Data
Nov. 22, 2005 (JP) JP2005-337133
Nov. 22, 2005 (JP) JP2005-337134
Nov. 22, 2005 (JP) JP2005-337135
Nov. 22, 2005 (JP) JP2005-337136
Dec. 1, 2005 (JP) JP2005-347667
Dec. 9, 2005 (JP) JP2005-356018
Mar. 16, 2006 (JP) JP2006-073207

(51) Int. Cl. F16C 9/00

(52) U.S. Cl. 384/457

(57) ABSTRACT

A needle roller bearing comprises an outer ring having a plurality of outer ring members split by split lines extending in the axial direction of the bearing, and a plurality of needle rollers arranged on the track surface of the outer ring so that they can roll. The outer ring is split by a load applied to its end surface in the direction crossing the end surface.

### BACKGROUND OF THE INVENTION

1. Field of the Invention

The present invention relates to a crank shaft supporting structure used in an engine of a car and the like.

2. Description of the Background Art

As shown in FIG. 25, a crank shaft 101 comprises a shaft 102, a crank arm 103, a crank pin 104 for arranging a con-rod between the adjacent crank arms 103. As shown in FIGS. 26 and 27, the shaft 102 is rotatably supported by a sliding bearing 105. Since the sliding bearing 105 has high load capacity, it is suitable for use under a high load environment. Furthermore, a cylinder block 107 (referred to as an “engine block” also hereinafter) and a bearing cap 108 are mounted on the outside the sliding bearing 105.

Referring to FIG. 27, since the sliding bearing 105 cannot support an axial load, a thrust washer 106 is arranged between the crank arm 103, and the engine block 107 and the bearing cap 108 in order to prevent the crank shaft 101 from moving in the axial direction. In addition, at least one thrust washer 106 may be arranged when the plurality of shafts 102 are provided.

In addition, in accordance with the increasing demand for a car that is low in fuel cost and has low noise level and less oscillation in view of the environment in recent years, instead of the sliding bearing 105 to support the shaft 102, it is proposed to use a needle roller bearing 111 comprising an outer ring 112, needle rollers 113 arranged along the inner diameter surface of the outer ring 112 and a retainer 114 retaining the interval of the adjacent needle rollers 113 as shown in FIGS. 28 and 29.

According to the needle roller bearing 111, since the needle roller 113 and the track surface are linearly in contact with each other, there is an advantage that high load capacity and high rigidity can be provided for a small bearing projected area, so that it is widely used in various kinds of fields such as a car or a two-wheel vehicle engine. In addition, although the needle roller bearing 111 is low in load capacity as compared with the sliding bearing 105, since friction resistance at the time of rotation is small, rotation torque and a fueling amount to the support part can be reduced.

However, as shown in FIG. 26, since the crank arms 103 are provided at both ends of the shaft 102, the needle roller bearing 111 cannot be pressed in the axial direction. Thus, a bearing that can be used in such case is disclosed in U.S. Pat. No. 1,921,488, for example.

According to the needle roller bearing disclosed in the U.S. Pat. No. 1,921,488, it comprises an outer ring 112 split into outer ring members 112a and 112b by split lines 112c extending in the axial direction of the bearing as shown in FIG. 30 and a retainer 114 comprising two semicircle-shaped split retainers as shown in FIGS. 32A and 32B. Alternatively, the needle roller bearing may comprise an outer ring 112 split into outer ring members 112a and 112b by split lines inclined at a predetermined angle in the axial direction.

According to the needle roller bearing disclosed in the U.S. Pat. No. 1,921,488, when it is incorporated in the shaft 102 sandwiched by the crank arms 103 of the crank shaft 101, the retainer 114 housing the needle rollers and the outer ring members 112a and 112b can be incorporated in the diameter direction, respectively.

At this time, since both outer rings 112 and retainers 114 are split into two parts, it is necessary to provide means for preventing the retainer 114 from falling off when the outer ring 112 is incorporated. This complicates the incorporating operation procedures and needs a special member for preventing the retainer 114 from falling off in some cases, which increases the number of operation steps and an operation cost.

In addition, as shown in FIG. 33A, the outer ring 112 ideally has a perfect cylindrical shape. However, in practice, the outer ring members 112a and 112b are shifted in the diameter direction and the split parts are shifted to generate a step part as shown in FIG. 33B. Furthermore, this step part becomes large as incorporating precision gets worse.

In this case, when the needle roller 113 passes through the step part, an abnormal sound is generated. The abnormal sound becomes loud as the step part becomes large and as the bearing rotation is speeded up, which becomes a big problem for the bearing that supports the shaft rotating at high speed such as the crank shaft 101.

In addition, according to the retainer 114 shown in FIGS. 32A and 32B, the split parts of the retainer 114 could be shifted in the axial direction at the time of the bearing rotation. Thus, an eccentric load is applied to the outer ring 112 and the crank shaft 101, and a trouble such as peeling or flaking could be generated at an early stage.

In addition, the needle roller bearing 111 having the above constitution is elastically deformed by the load applied from the crank shaft 101 at the time of rotation. At this time, in the case of the retainer 114, for example the split part could be largely deformed and corresponding end surfaces come in contact with each other to generate a metallic sound.

Furthermore, when the metals come in contact to each other, the contact part could be abraded and a lubricant agent could deteriorate because abrasion powder is mixed in. Since this becomes conspicuous as the rotation of the bearing is speeded up, the above is a serious problem for the needle roller bearing 111 supporting the crank shaft 101.

Thus, when the needle roller bearing 111 is used to support the crank shaft 101, as shown in FIG. 34, recessed parts are provided in both of the outer ring 112 and the engine block 107 and fixed by a fixing pin 115. Since the needle roller bearing 111 can support the axial load at a flange 112d, it is not necessary to provide a thrust washer and the like.

However, according to the needle roller bearing 111, the outer ring 112 having the flange 112d is highly rigid and great force is required to split the outer ring 112 into the two outer ring members 112a and 112b. Furthermore, when great force is applied to the outer ring 112 to split it, the outer ring 112 could be deformed.

Meanwhile, as shown in FIG. 35, a needle roller bearing 116 having the same constitution as that of the needle roller bearing 111 basically but having no flange at both ends of an outer ring 117 may be used. However, in this case, since there is no means for preventing the retainer 119 from moving in the axial direction, the needle roller 118 could fall off the track surface of the outer ring 117.

A method of splitting the outer ring 112 is disclosed in Japanese Unexamined Patent Publication No. 7-317778, for example. According to the Japanese Unexamined Patent Publication No. 7-317778, as shown in FIG. 36A, V-shaped grooves 112e each having a V-shaped sectional configuration are formed on both end surfaces of the outer ring 112 and as shown in FIG. 36B, the outer ring 112 is split into two outer ring members 112a and 112b when pressure is applied to the parts in which the V-shaped grooves 112e are formed from both sides in the diameter direction.

When the outer ring 112 is split by the above method, the vicinity of the split part is largely deformed inward in the diameter direction as shown in FIG. 37A. In addition, when the outer ring 112 is incorporated in the cylinder block 107 and the bearing cap 108, the diameter in the vicinity of the split part becomes smaller than a designed value and the diameter in the center becomes larger than the designed value as shown in FIG. 37B.

In this case, since the space formed between the shaft 102 and the inner diameter surface of the outer ring 112 in which the needle rollers 113 roll (referred to as the “rolling space” hereinafter) is varied in the circumferential direction, the rolling of the needle roller 113 becomes unstable. As a result, a noise or oscillation could be generated at the time of the rotation of the bearing, or a trouble such as flaking or seizing due to the lack of an oil film could be generated. In addition, when the thickness of the outer ring 112 is decreased, the deformation due to the splitting becomes large and this problem becomes serious.

As another bearing to support the shaft 102 of the crank shaft 101, a roller bearing 125 disclosed in Japanese Unexamined Patent Publication No. 2004-232724, for example is employed in some cases.

As shown in FIGS. 38 and 39, the roller bearing 125 disclosed in the Japanese Unexamined Patent Publication No. 2004-232724 comprises a two-split outer ring (not shown), a plurality of rollers 126 arranged along the inner diameter surface of the two-split outer ring, and a two-split retainer 127. According to the roller bearing 125 having the above constitution, since the outer ring and the retainer 127 can be incorporated from the diameter direction of the shaft 102, it is said that the roller bearing is suitable for use to support the shaft 102.

A problem such as the damage of the two-split retainer 127 due to the contact of the end surfaces of the two-split retainer 127 in the circumferential direction at the time of the rotation of the bearing has been pointed out. Thus, according to the Japanese Unexamined Patent Publication No. 2004-232724, the section modulus of a pillar part close to the end surface of the two-split retainer 127 in the circumferential direction is increased to prevent the damage of the retainer 127.

In the Japanese Unexamined Patent Publication No. 2004-232724, assuming that the load applied to a pillar part 127a that is closest to the end surface of the retainer 127 in the circumferential direction is the highest, when the width of the pillar part 127a that is closest to the end surface in the circumferential direction is “Wa”, the width of a pillar part 127b adjacent to the pillar part 127a is “Wb”, and the width of another pillar part 127c in the circumferential direction is “Wc”, they are set so as to satisfy the relation Wa>Wb>Wc to make the section modulus of the pillar part 127a greater than those of the other pillar parts 127b and 127c.

However, according to a rotation test performed for a bearing having a retainer in which all pillar parts have the same width, it is reported that the second pillar part from the end surface of the two-split retainer in the circumferential direction was damaged, so that it has been confirmed that the load applied to the pillar part 127b is highest in the bearing for supporting the shaft 102 of the crank shaft 101 actually.

### SUMMARY OF THE INVENTION

It is an object of the present invention to provide a crank shaft supporting structure in which an incorporating operation is easy through the use of a needle roller bearing that prevents a retainer from falling off at the time of incorporating.

It is another object of the present invention to provide a crank shaft supporting structure having a needle roller bearing that can prevent a retainer from moving in an axial direction even when an outer ring has no flange.

It is still another object of the present invention to provide a crank shaft supporting structure in which an abnormal sound generated when a needle roller passes through a step part of an outer ring is prevented.

It is still another object of the present invention to provide a needle roller bearing in which the split parts of a retainer are prevented from being in contact with each other. In addition, it is an object to provide a crank shaft supporting structure in which such needle roller bearing is used to reduce noise.

It is still another object of the present invention to provide a crank shaft supporting structure having high reliability through the use of a needle roller bearing having a retainer in which split parts are prevented from being shifted in the axial direction.

It is still another object of the present invention to provide a crank shaft supporting structure having high durability and reliability through the use of a needle roller bearing in which each part is designed so as to have strength according to a load applied to a retainer.

It is still another object of the present invention to provide a method of splitting an outer ring of a needle roller bearing in which the vicinity of a split part is not likely to be deformed.

A needle roller bearing according to the present invention comprises an outer ring having a plurality of outer ring members split by split lines extending in the axial direction of the bearing and a plurality of needle rollers arranged on the track surface of the outer ring so that they can roll. Thus, a load is applied to the end surface of the outer ring in the direction crossing the end surface to split the outer ring.

Since a load is not applied in the diameter direction when the outer ring member is formed, a deformed amount can be small in the vicinity of the split parts. As a result, the needle roller bearing enables the needle rollers to smoothly roll.

Preferably, the outer ring has a V-shaped groove having a V-shaped sectional configuration at its end surface and the angle θ of the V-shaped groove is within a range of 5°≦θ≦150°, and the width “w” of the outer ring in the axial direction and the depth “d” of the V-shaped groove has a relation d/w≦0.2.

When the angle θ is too large, since the degree of stress concentration generated at the root part of the V-shaped groove becomes small, the load required to split the outer ring becomes high. Meanwhile, when the angle θ is too small, it becomes difficult to form the V-shaped groove. Thus, in view of the split processability of the outer ring and processability of the V-shaped groove, the angle θ of the V-shaped groove is preferably within the range of 5°≦θ≦150°. In addition, when the depth “d” of the V-shaped groove is too large, the needle roller and the V-shaped groove interfere with each other and the rolling defect of the needle roller could be generated. Thus, the problem can be solved by setting the depth such that d/w≦0.2.

Preferably, the thickness “t” of the outer ring is t≦5 mm. As the thickness “t” of the outer ring becomes small, the deformed amount becomes large in the vicinity of the split parts. Thus, when the present invention is applied to the outer ring having the thickness of t≦5 mm, a higher effect can be expected.

Preferably, the needle roller bearing further comprises a retainer having a cut part extending in the axial direction on the circumference and a buffer member at the end surface of the cut part. According to the above constitution, since the end surfaces of the cut part of the retainer are not directly in contact with each other, a metallic sound is prevented from being generated and abrasion at the contact part can be prevented.

According to the present invention, since the buffer member is arranged at the cut part of the retainer, the needle roller bearing prevents the metallic sound due to the contact of the end surfaces. In addition, when such bearing is used to support the shaft of the crank shaft, the crank shaft supporting structure can be low in noise level.

A crank shaft supporting structure according to the present invention comprises a crank shaft having a shaft and crank arms positioned at both ends of the shaft and the needle roller bearing for supporting the crank shaft rotatably as set forth in claim 1. Focusing on the needle roller bearing, the needle roller bearing further comprises a retainer whose both ends project from the end surface of the outer ring to be in contact with the crank arms.

According to the above constitution, since the movement of the retainer in the axial direction is prevented by the wall surface of the crank arm, even when the outer ring has no flange, the needle roller does not fall off the track surface of the outer ring. As a result, the crank shaft supporting structure can keep the smooth rolling of the needle roller.

According to the present invention, since both ends of the retainer abut on the crank arms to prevent the retainer from moving in the axial direction, the crank shaft supporting structure can keep the smooth rolling.

A crank shaft supporting structure according to another aspect of the present invention comprises a crank shaft and the needle roller bearing for supporting the crank shaft rotatably as set forth in claim 1. Focusing on the needle roller bearing, the needle roller bearing further comprises an integral retainer having a cut part extending in the axial direction on the circumference.

According to the needle roller bearing having the above constitution, the retainer is elastically deformed to be incorporated in the crank shaft and then the outer ring member is incorporated in the diameter direction. At this time, since the retainer does not fall off because of disassembly, the crank shaft supporting structure enables a simple incorporating operation.

According to the present invention, since the retainer is the integral type, the retainer is prevented from falling off when the outer ring is incorporated, so that the crank shaft supporting structure enables a simple incorporating operation.

A crank shaft supporting structure according to still another aspect comprises a crank shaft and the needle roller bearing for supporting the crank shaft rotatably as set forth in claim 1. The split lines of the outer ring are provided apart from a maximum radial load point of the needle roller bearing to both sides in the circumferential direction by 50° or more.

As described above, when the split line of the outer ring is arranged at a position apart from the maximum radial load point, the abnormal sound generated when the needle roller passes through the step part can be prevented. As a result, the noise level of the crank shaft supporting structure can be low. In addition, the “maximum radial load point” used in this specification means a point to which the highest radial load is applied on the circumference of the outer ring of the needle roller bearing incorporated in the crank shaft.

Preferably, the split lines are provided apart from a symmetric position to the maximum radial load point across the bearing center to both sides in the circumferential direction by 50° or more. In general, a high radial load is applied to a point symmetric to the maximum radial load point across the bearing center. Thus, when the split line of the outer ring is arranged at a position apart from this point, the noise level of the crank shaft supporting structure can be low.

According to the present invention, since the step part of the outer ring is arranged at a position apart from the maximum radial load point, the crank shaft supporting structure in which the abnormal sound to be generated when the needle roller passes through the step part is prevented can be provided.

A crank shaft supporting structure according to still another aspect of the present invention comprises a crank shaft and the needle roller bearing for supporting the crank shaft rotatably as set forth in claim 1. Focusing on the needle roller bearing, the needle roller bearing further comprises a retainer having cut parts extending in the axial direction on the circumference, a projected part at one cut part and a recessed part for receiving the projected part, at the other cut part, and the gap δ between the projected part and the recessed part in the axial direction is such that 0≦δ≦0.2 mm.

As described above, when the gap δ between the projected part and the recessed part in the axial direction is set such that 0≦δ≦0.2 mm, the cut parts of the retainer can be prevented from being shifted. As a result, since the trouble such as peeling or flaking can be prevented, the crank shaft supporting structure can have long life and high reliability. In addition, it is preferable that the retainer is formed of a resin material in view of processability.

According to the present invention, since the gap between the projected part and the recessed part in the axial direction is set within the predetermined range, the retainer can be prevented from being shifted in the axial direction, so that the crank shaft supporting structure can have a long life and high reliability.

A crank shaft supporting structure according to still another aspect of the present invention comprises a crank shaft and the needle roller bearing for supporting the crank shaft rotatably as set forth in claim 1. Focusing on the needle roller bearing, the needle roller bearing further comprises a retainer formed by circumferentially connecting a plurality of retainer segments each having a plurality of pockets for housing the needle rollers and comprising an arc-shaped ring part and a plurality of pillar parts projecting from the end surface of the ring part in the axial direction. The pillar part comprises two first pillar parts positioned closest to both end surfaces of the ring part in the circumferential direction, two second pillar parts adjacent to the two first pillar parts, respectively and third pillar parts arranged between the two second pillar parts, and the width of the second pillar part in the circumferential direction is larger than those of the other pillar parts.

As described above, since the strength of the second pillar part to which the highest load is applied at the time of the bearing rotation is increased, the crank shaft supporting structure can be highly durable and reliable.

Preferably, the retainer segment comprises a first pocket formed between the first pillar part and the second pillar part, a second pocket formed between the second pillar part and the third pillar part adjacent to the second pillar part, and a third pockets formed between the adjacent third pillar parts. When it is assumed that the central angle formed between the end surface of the ring part in the circumferential direction and the first pocket is “α”, the central angle formed between the first pocket and the second pocket is “β” and the central angle formed between the second pocket and the third pocket adjacent to the second pocket is “γ”, the relations such that α≠β, β≠γ, and γ≠α are satisfied.

The diameters of all of the needle rollers have to be the same in view of keeping the smooth rotation of the needle roller bearing. When all of the needle rollers have the same diameter, the opening widths of all of the pockets have to be the same. Since the retainer of the needle roller bearing used in the crank shaft supporting structure according to the present invention have different dimensions in the pillar parts in the circumferential direction, in order to make the opening widths of the pockets uniform, the pitches (α, β, γ) of the adjacent pockets have to be irregular.

Preferably, the needle roller bearing further comprises an outer ring in which an annular member is formed by cutting and a plurality of split lines extending in the axial direction on the circumference of the annular member are formed by natural splitting. When the outer ring is split by the above method, since the manufacturing steps can be simplified, the crank shaft supporting structure is low in cost.

Preferably, the retainer segment comprises SNCM or SCM as a starting material and formed through a carburizing or carbonitriding treatment. When the retainer segment is manufactured by the above method, the strength of the whole retainer segment can be enhanced. As a result, the crank shaft supporting structure can have higher reliability.

Preferably, the retainer is formed of a resin material. Since the resin material has high elastic deformability, it is very suitable for the retainer material to be incorporated according to the above procedure.

Preferably, the crank shaft is used in a multiple cylindered engine. The crank shaft used in the multiple cylindered engine has a shaft whose both ends are sandwiched by the crank arms and whose number is increased in proportion to the number of cylinders. When the above needle roller bearing is used in such crank shaft, a higher effect can be expected.

According to the present invention, since the strength of the second pillar part to which the highest load is applied at the time of the bearing rotation is enhanced, the crank shaft supporting structure can be superior in durability and high in reliability.

A method of splitting an outer ring of a needle roller bearing according to the present invention is a method of splitting an outer ring of a needle roller bearing comprising the outer ring having a plurality of outer ring members split by split lines extending in the axial direction of the bearing, and a plurality of needle rollers arranged on the track surface of the outer ring so that they can roll. More specifically, the method comprises a step of splitting a cylindrical material by applying a load to the end surface of the cylindrical material in the direction crossing the end surface to split the outer ring.

For example, the method comprises a step of forming a notch extending in the diameter direction, on one end surface of the cylindrical material in the axial direction, a step of setting the outer ring such that the end surface having the notch is arranged on the lower side and a space is provided in the vicinity of the notch, and a step of splitting the cylindrical material by applying the load to the end surface not having the notch.

Alternatively, the method comprises a step of forming notches extending in the diameter direction, on both end surfaces of the cylindrical material in the axial direction, a step of setting the outer ring such that the one end surface is arranged on the lower side and a space is provided in the vicinity of the notch, and a step of splitting the cylindrical material by applying the load to the other end surface except for the notch.

Since a load is not applied to the outer ring in the diameter direction according to the above methods, a deformed amount can be small in the vicinity of the split part. As a result, the needle roller can stably roll and a trouble can be prevented.

According to the present invention, since the load is applied to the end surface of the cylindrical material to split the outer ring by the method of splitting the outer ring of the needle roller bearing, the deformation in the vicinity of the split line can be prevented and the needle roller can stably roll.

### BRIEF DESCRIPTION OF THE DRAWINGS

FIG. 1 is a view showing a crank shaft supporting structure in its incorporated state according to one embodiment of the present invention;

FIG. 2 is a view showing an outer ring used in a needle roller bearing in FIG. 1;

FIG. 3 is a view showing the outer ring in FIG. 2 split by natural splitting;

FIG. 4 is an enlarged view of a split part in FIG. 3;

FIG. 5 is a side view showing a retainer of the needle roller bearing in FIG. 1;

FIG. 6 is a front view showing the retainer of the needle roller bearing in FIG. 1;

FIG. 7 is an enlarged view showing a part Q in FIG. 6;

FIG. 8A is a view showing the incorporated crank shaft supporting structure taken in an axial direction according to one embodiment of the present invention;

FIG. 8B is a view showing the incorporated crank shaft supporting structure taken in a direction perpendicular to the axial direction according to one embodiment of the present invention;

FIG. 9 is a view showing a crank shaft supporting structure according to another embodiment of the present invention;

FIG. 10A is a front view showing a retainer of a needle roller bearing in FIG. 9;

FIG. 10B is a side sectional view showing the retainer of the needle roller bearing in FIG. 9;

FIG. 11 is a view showing a state in which the crank shaft supporting structure in FIG. 9 is incorporated;

FIG. 12 is a view showing a needle roller bearing to be used in FIG. 13;

FIG. 13 is a view showing a crank shaft supporting structure according to another embodiment of the present invention;

FIG. 14A is a front view showing a retainer of the needle roller bearing in FIG. 12;

FIG. 14B is a side sectional view showing the retainer of the needle roller bearing in FIG. 12;

FIG. 15 is a view showing a distribution of radial loads applied to the needle roller bearing in FIG. 12;

FIG. 16 is a view showing a test result to confirm the effect of the present invention;

FIG. 17 is a view showing a crank shaft supporting structure according to another embodiment of the present invention;

FIG. 18 is a view showing a state in which needle rollers are housed in a retainer used in the needle roller bearing;

FIG. 19 is a view showing widths of pillar parts of a retainer segment used in the needle roller bearing;

FIG. 20 is a view showing pitches between pockets of the retainer segment used in the needle roller bearing;

FIG. 21A is a front view showing a method of splitting the outer ring of the needle roller bearing according to one embodiment of the present invention;

FIG. 21B is a plan view showing the method of splitting the outer ring of the needle roller bearing according to one embodiment of the present invention;

FIG. 22A is a view showing roundness before the outer ring split by the method in FIGS. 21A and 21B is incorporated;

FIG. 22B is a view showing roundness after the outer ring split by the method in FIGS. 21A and 21B has been incorporated;

FIG. 23A is a front view showing a method of splitting the outer ring of the needle roller bearing according to another embodiment of the present invention;

FIG. 23B is a plan view showing the method of splitting the outer ring of the needle roller bearing according to another embodiment of the present invention;

FIG. 24 is a view showing various kinds of dimensions of the outer ring used in FIGS. 21A and 21B;

FIG. 25 is a view showing a conventional crank shaft;

FIG. 26 is an enlarged view showing a part P in FIG. 25;

FIG. 27 is a view showing a conventional crank shaft supporting structure in which a thrust washer is disposed between a crank arm and an engine block;

FIG. 28 is a view showing a conventional needle roller bearing to support the shaft of the crank shaft;

FIG. 29 is a view showing a conventional needle roller bearing to support the shaft of the crank shaft;

FIG. 30 is a view showing a conventional split outer ring;

FIG. 31 is a view showing a conventional split outer ring;

FIG. 32A is a view showing one side of a conventional split retainer;

FIG. 32B is a view showing an abutting part of the conventional retainer;

FIG. 33A is a view showing an example in which the outer ring members are combined with accuracy;

FIG. 33B is a view showing an example in which the outer ring members are combined out of alignment;

FIG. 34 is a view showing a conventional crank shaft supporting structure in which a needle roller bearing having flanges at both ends supports a shaft;

FIG. 35 is a view showing a conventional crank shaft supporting structure in which a needle roller bearing having no flanges at both ends supports the shaft;

FIG. 36A is a view showing a V-shaped groove of an outer ring before split;

FIG. 36B is a view showing a conventional method of splitting an outer ring;

FIG. 37A is a view showing roundness before the outer ring split by the method in FIGS. 36A and 36B is incorporated;

FIG. 37B is a view showing roundness after the outer ring split by the method in FIGS. 36A and 36B has been incorporated;

FIG. 38 is a view showing a conventional needle roller bearing; and

FIG. 39 is a view showing a retainer of the needle roller bearing in FIG. 38.

### DESCRIPTION OF THE PREFERRED EMBODIMENTS

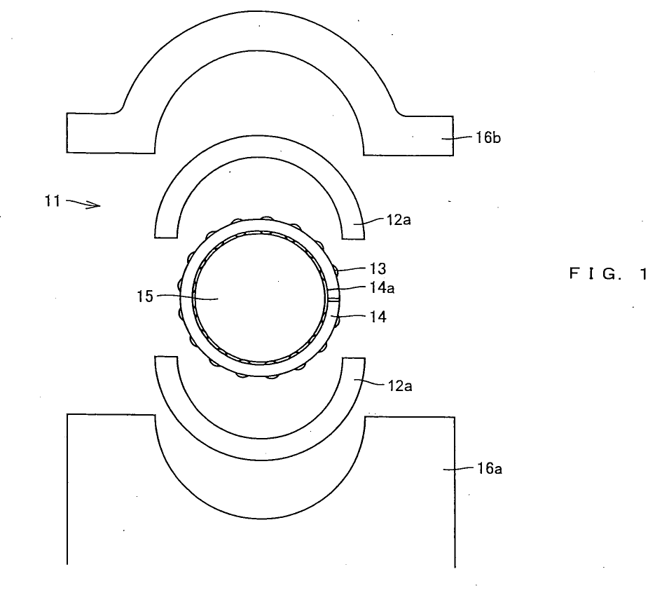

A crank shaft supporting structure according to one embodiment of the present invention will be described with reference to FIG. 1 hereinafter.

The crank shaft supporting structure shown in FIG. 1 comprises a crank shaft 15, a cylinder block 16a, a bearing cap 16b, and a needle roller bearing 11 arranged between the crank shaft 15 and the bearing cap 16b and supporting the crank shaft 15 rotatably.

The needle roller bearing 11 comprises an outer ring 12 having a plurality of outer ring members 12a split by split lines extending in the axial direction of the bearing, a plurality of needle rollers arranged on the track surface of the outer ring 12 so that they can roll, and an integral retainer 14 having a cut part 14a extending in the axial direction on the circumference.

According to the needle roller bearing 11, since the needle roller 14 and the track surface are linearly in contact with each other, high load capacity and high rigidity can be provided for its small bearing projected area, so that it is suitable for use in a car, a two-wheel vehicle engine and the like.

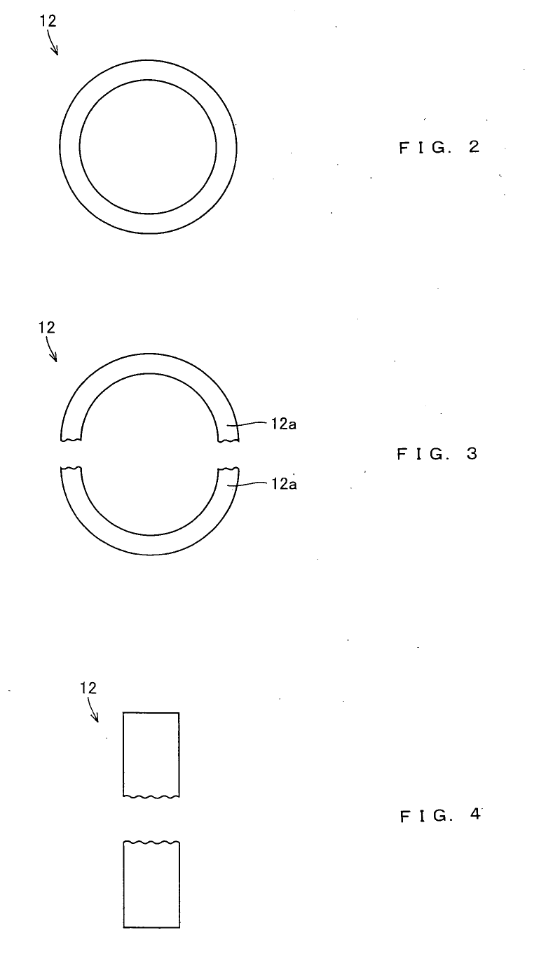

The outer ring shown in FIG. 1 will be described with reference to FIGS. 2 to 4. In addition, FIG. 2 is a view showing a state of the outer ring 12 before split, FIG. 3 is a view showing a state of the outer ring 12 split by natural splitting, and FIG. 4 is an enlarged view of the split part of the outer ring 12.

Referring to FIG. 2, a cylindrical annular member is formed by a cutting process and the like to provide the outer ring 12. In addition, since the inner diameter surface of the outer ring 12 functions as the track surface of the needle roller bearing 14, it is ground for secure the smooth rotation of the needle rollers 14.

Referring to FIG. 3, a plurality of split lines extending in the axial direction are formed on the circumference of the annular member by applying shock load to the outer diameter surface or the end surface of the annular member. Thus, the outer ring members 12a are provided. According to this embodiment, the outer ring member 12a is in the form of a semicircle having a central angle of 180°. Referring to FIG. 4, since the end surface of the split part of the outer ring member 12a is not ground, the configuration of it is indented because of natural splitting. When the bearing is used, the cylindrical outer ring is provided by abutting the corresponding end surfaces. In addition, the above manufacturing method is called “natural splitting”.

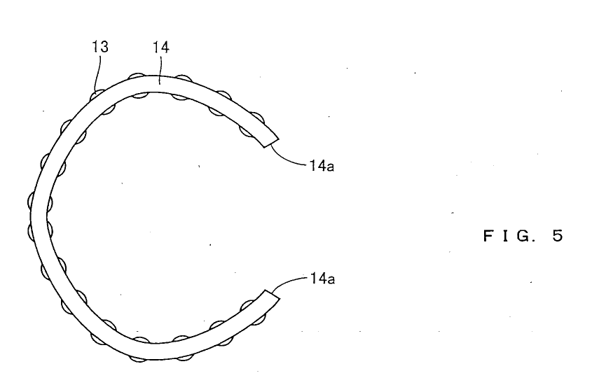

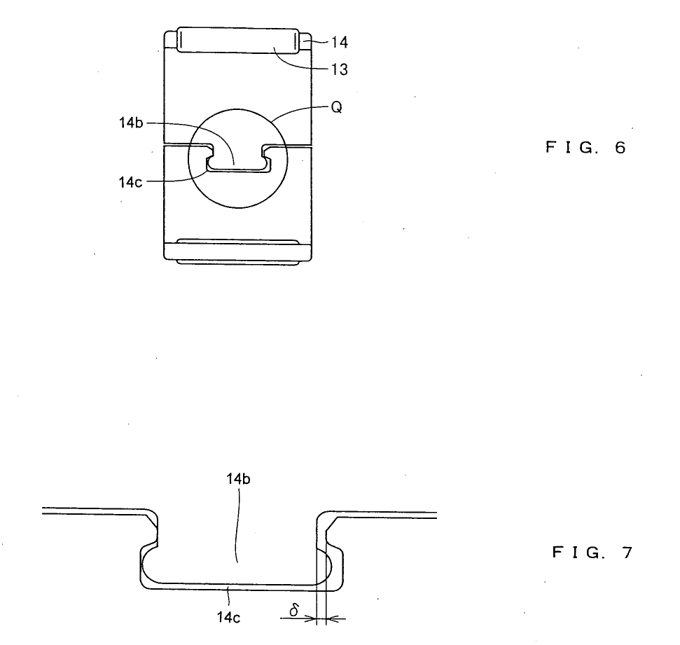

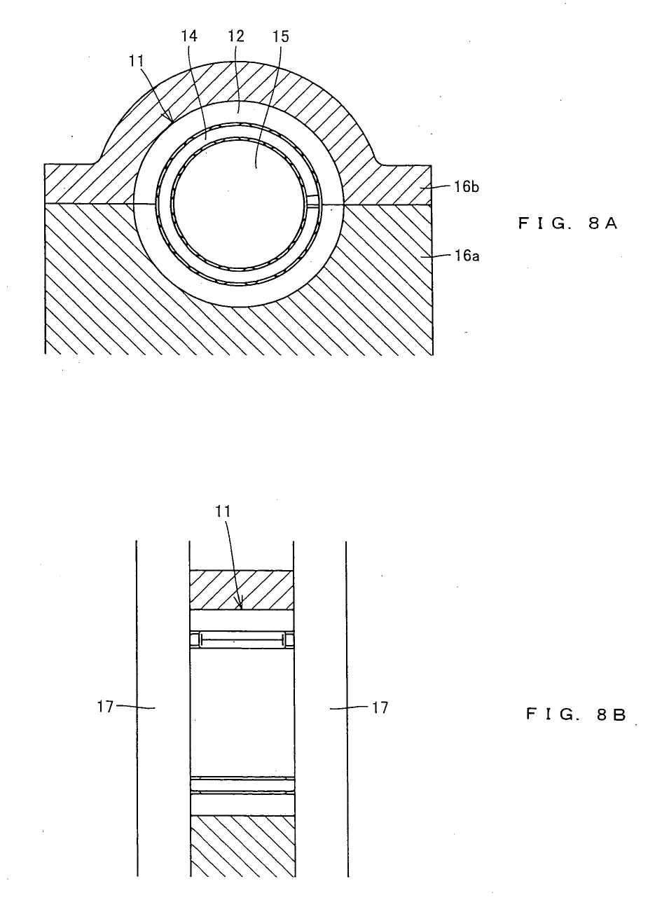

The retainer 14 shown in FIG. 1 will be described with reference to FIGS. 5 to 7. In addition, FIG. 5 is a side view of the retainer 14, FIG. 6 is a front view of the retainer 14, and FIG. 7 is an enlarged view showing a part “Q” in FIG. 6. First, referring to FIG. 5, the retainer 14 is an integral retainer having the cut part 14a at one portion on the circumference. The retainer 14 is formed of a resin material.

Referring to FIG. 6, the retainer 14 has a projected part 14b on one side of the cut part Q and a recessed part 14c on the other side thereof to receive the projected part 14b, and when it is incorporated, the projected part 14b is fitted in the recessed part 14c so that they are fixed. Thus, as shown in FIG. 7, the gap δ between the projected part 14b and the recessed part 14c in the axial direction is set such that 0≦δ≦0.2 mm.

In this constitution, the shift of the retainer 14 in the cut part Q in the axial direction can be minimized. Thus, the trouble of the outer ring 12 or the crank shaft 15 such as peeling, flaking can be prevented, so that the crank shaft supporting structure has a long life and high reliability.

Here, although it is ideal that the gap δ between the projected part 14b and the recessed part 14c in the axial direction is zero, it is very difficult to implement the above precision in view of manufacturing error and the like. However, when δ≦0.2 mm, since an eccentric load applied to the outer ring 12 or the crank shaft 15 is small, the trouble caused by the shift of the retainer 14 can be sufficiently prevented from being generated.

A method of incorporating the needle roller bearing 11 having the above constitution into the crank shaft 15 will be described.

First, the retainer 14 that has incorporated needle roller 13 in each pocket previously is prepared. Then, the retainer 14 is incorporated such that the cut parts 14a are elastically deformed to the degree it can be incorporated in the crank shaft 15. At this time, the projected part 14b and the recessed part 14c of the retainer 14 are engaged and fixed to the crank shaft 15. Finally, the outer ring members 12a are incorporated in the crank shaft 15 in the diameter direction and then the cylinder block 16a and the bearing cap 16b are incorporated.

As a result, as shown in FIGS. 8A and 8B, the crank shaft 15, the retainer 14, the outer ring members 12a, and the inner diameter surface of the cylinder block 16a and the bearing cap 16b are arranged concentrically, so that the needle rollers 13 can roll stably, According to the above incorporating steps, the needle roller bearing 11 can be incorporated into a shaft whose both ends are sandwiched by crank arms. Furthermore, there is no possibility that the retainer 14 falls off when the outer ring member 12a is incorporated. Therefore, the incorporating operation is simple and it is not necessary to provide a member especially for preventing the retainer 14 from falling off. As a result, the number of operating steps and the operation cost can be reduced.

At this time, although the retainer 14 may be a metal retainer manufactured by pressing or cutting a metal material, when it is a resin retainer manufactured by injection molding a resin material having an elastic deformation property, the incorporating operation becomes simple.

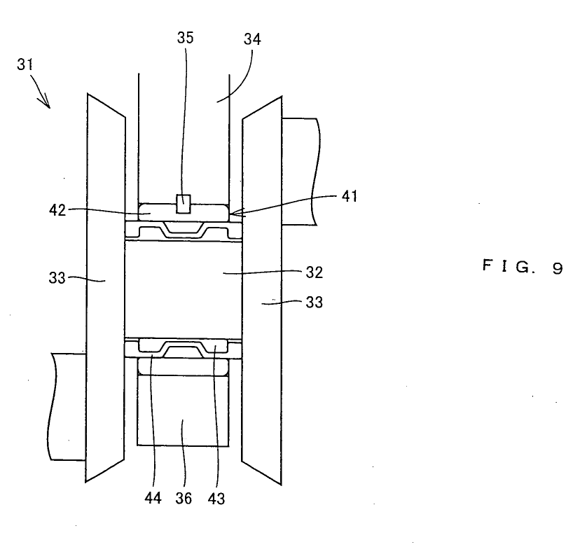

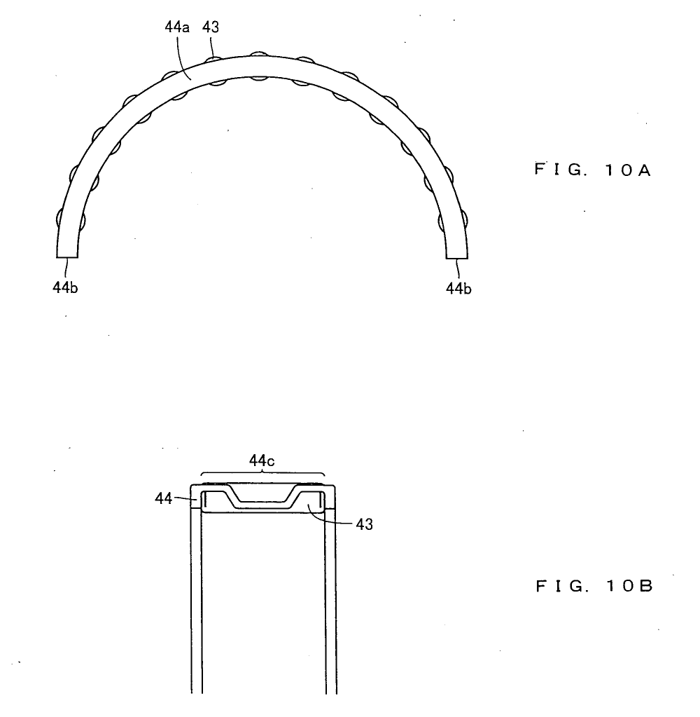

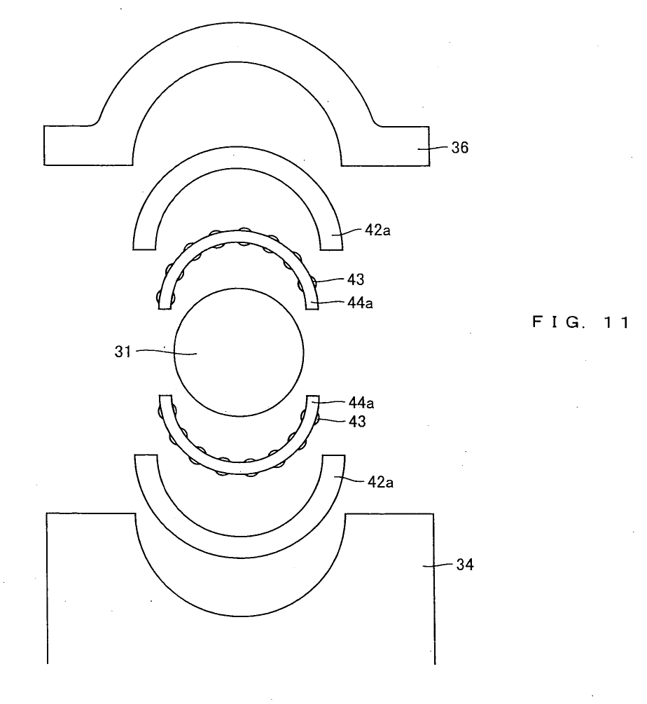

A crank shaft supporting structure according to another embodiment of the present invention will be described with reference to FIGS. 9, 10A and 10B.

The crank shaft supporting structure shown in FIG. 9 comprises a crank shaft 31 having a shaft 32 and crank arms 33 positioned at both ends of the shaft 32, and a needle roller bearing 41 supporting the shaft 32 of the crank shaft 31 rotatably.

The needle roller bearing 41 comprises an outer ring 42, a plurality of needle rollers 43 arranged on the track surface of the outer ring 42 so that they can roll, and a retainer 44 whose both ends project from the ends of the outer ring 42 and have contact with the crank arms 33. In addition the outer ring 42 is fixed to the engine block 34 and the bearing cap 36 with a fixing pin 35.

The outer ring 42 is the split type outer ring formed by the “natural splitting” shown in FIGS. 2 to 4. Since this outer ring 42 does not have any flange at the end in the axial direction, great force is not needed when it is split into two. This provides the effect that the outer ring 42 is prevented from being deformed at the time of splitting in addition to the effect that the manufacturing can be simplified. Furthermore, when it does not have the flange, since the roller can be as long as possible in a limited space, the needle roller bearing 41 can provide a large load capacity.

Meanwhile, the retainer 44 is a metal retainer manufactured by pressing or cutting a metal material, and it is formed by combining two split retainers 44a split at cut parts 44b in the circumferential direction as shown in FIG. 10A. In addition, as shown in FIG. 10B, the retainer 44 has a pocket 44c housing the needle roller 43.

According to the above needle roller bearing 41, both ends of the retainer 44 are in contact with the crank arms 33, even when the flange is not provided in the outer ring 42, the retainer 44 can be prevented from moving in the axial direction. As a result, since the needle roller 43 is prevented from falling off the track surface of the outer ring 42, the needle roller 43 can roll smoothly.

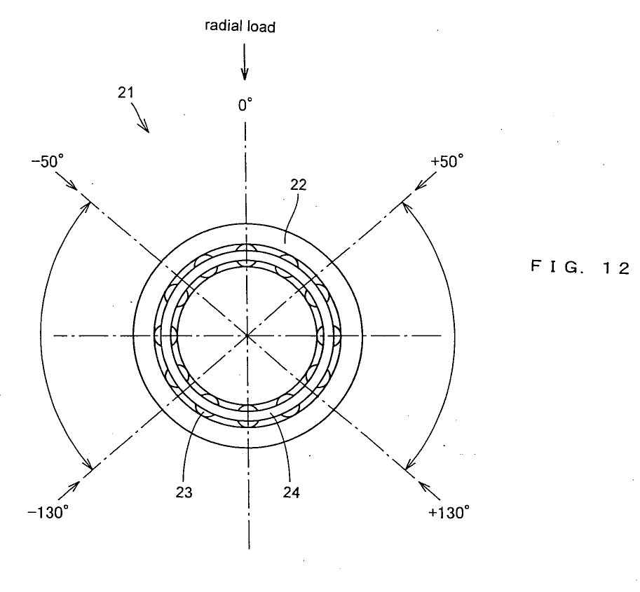

A method of incorporating the needle roller bearing 41 having the above constitution to the crank shaft 31 will be described with reference to FIG. 11 hereinafter.

First, one outer ring member 42a and the split retainer 44a incorporating the needle rollers 43 previously are put on the engine block 34. Then, the crank shaft 31 is put thereon and the other outer ring member 42a and the split retainer 44a incorporating the needle rollers 43 previously are put thereon. Finally, they are fixed by the bearing cap 36.

Although the above retainer 44 is the metal retainer manufactured by pressing or cutting the metal material in the above example, the present invention is not limited to this. For example, it may be a resin retainer manufactured by injection molding a resin material having high elastic deformability.

In addition, although the retainer 44 is the two-split type of retainer 44 having the two cut parts 44b on the circumference in the above example, the present invention is not limited to this. For example, it may be an integral retainer having one cut part on the circumference.

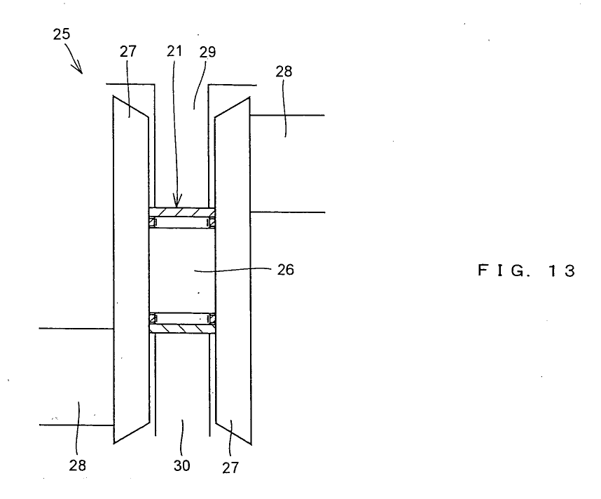

A crank shaft supporting structure according to another embodiment of the present invention will be described with reference to FIG. 13.

The crank shaft supporting structure shown in FIG. 13 comprises a crank shaft 25 having a shaft 26, crank arms 27 positioned on both ends of the shaft 26 and a crank pin 28 arranged on the other side of the shaft 26 across the crank arm 27, a needle roller bearing 21 supporting the crank shaft 25 rotatably, a crank case 29 and a crank case cap 30.

The needle roller bearing 21 comprises an outer ring 22 having a plurality of outer ring members 22a split by split lines extending in the axial direction of the bearing, a plurality of needle rollers 23 arranged on the track surface of the outer ring 22 so that they can roll, and a retainer 24 having pockets for housing the plurality of needle rollers as shown in FIG. 12. In addition, the outer ring 22 is the split type outer ring formed by the “natural splitting” shown in FIGS. 2 to 4.

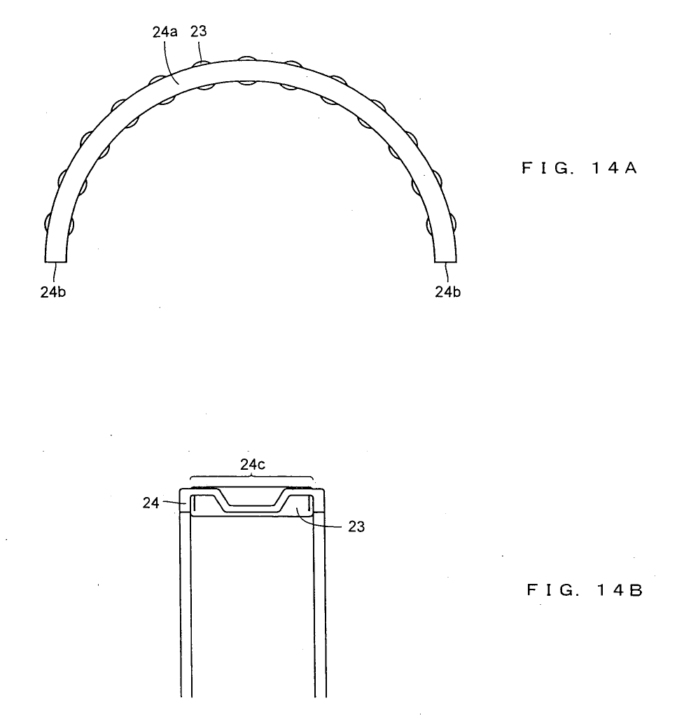

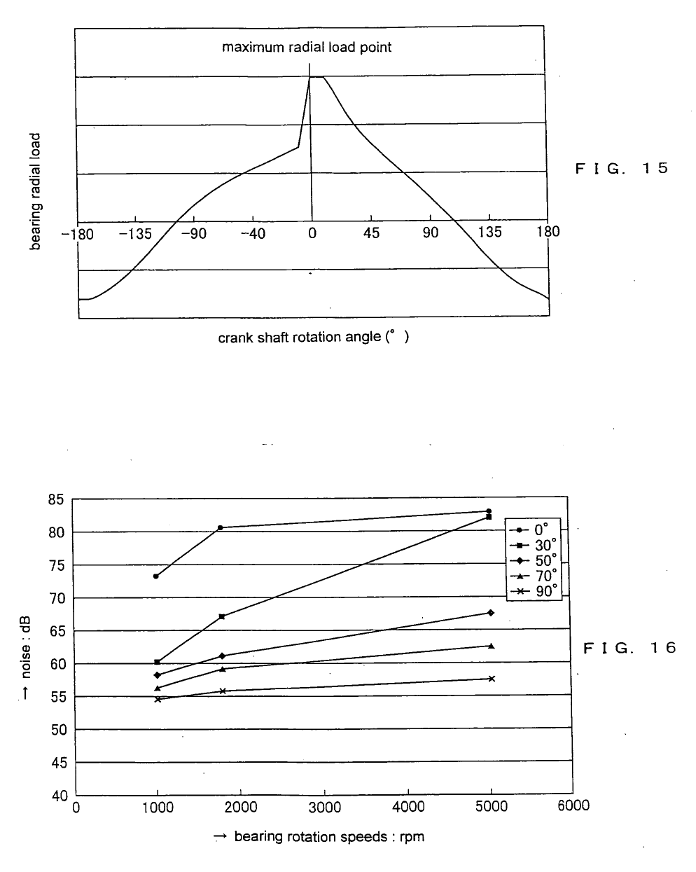

Meanwhile, the retainer 24 is formed by combining two split retainers 24a split by cut parts 24b in the circumferential direction as shown in FIG. 14A. In addition, as shown in FIG. 14B, it has pockets 24c for housing the needle rollers 23.

A method of incorporating the above needle roller bearing 21 into the crank shaft 25 will be described hereinafter.

First, the needle roller 23 is incorporated in each pocket of the retainer 24. Then, one outer ring member 22a is incorporated in the crank case 29, and one split retainer 24a, the crank shaft 25, the other split retainer 24a, and the other outer ring member 22a are set thereon. Finally, the crank case cap 30 is incorporated to fix them.

At this time, the split lines of the two outer ring members 22a are provided at positions apart from the maximum radial load point of the crank shaft supporting structure 25 to both sides in the circumferential direction by 50° or more. In this constitution, even when there is a step part at the abutting part of the outer ring members 22a, abnormal noise to be generated when the needle roller 23 passes the step part can be prevented. As a result, the crank shaft supporting structure can be low in noise level.

Furthermore, as shown in FIG. 15, since a high load is applied at a point opposite to the maximum radial load point across the center of the bearing in general, the split lines of the outer ring members 22a are provided at positions apart from that point to both sides in the circumferential direction by 50° or more. That is, they may be provided in the range of 50° to 130° on both sides of the maximum radial load point.

Then, in order to confirm the effect of the present invention, a test for measuring the noise during the rotation of the bearing was performed, changing the positional relation between the maximum radial load point of the crank shaft and the split line of the outer ring member 22a.

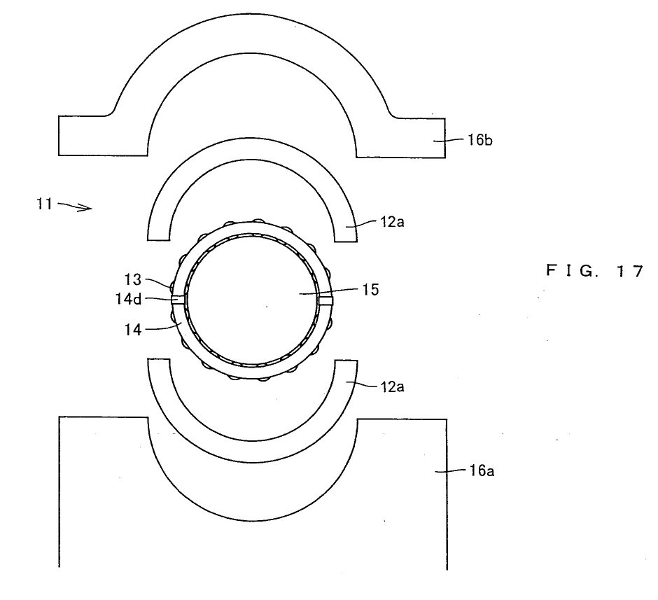

In addition, the crank shaft supporting structures used in the test includes a structure in which the maximum radial load point and the split line correspond to each other (at the point of 020 in the drawing), and structures in which both are shifted from each other by 30°, 50°, 70°, and 90°. In addition, the test was performed at the bearing rotation speeds of 1000 rpm, 1800 rpm, and 5000 rpm. The result is shown in Table 1 and FIG. 16.

TABLE 1

| Positional relation | | | |
|---|---|---|---|
| between the maximum radial | Bearing rotation speeds | | |
| load point and the split line | 1000 rpm | 1800 rpm | 5000 rpm |
| 0° | 73.0 dB | 80.6 dB | 82.8 dB |
| 30° | 60.1 dB | 67.0 dB | 82.1 dB |
| 50° | 58.3 dB | 61.1 dB | 67.5 dB |
| 70° | 56.5 dB | 59.3 dB | 62.5 dB |
| 90° | 54.6 dB | 56.0 dB | 58.0 dB |

Referring to Table 1 and FIG. 16, it has been confirmed that the noise level is low in the structure in which the split line of the outer ring member 22a is apart from the maximum radial load point by 50° or more. In addition, it has been confirmed that even when the rotation speed is changed, the noise level is not changed so much. Furthermore, it has been confirmed that the noise level is the lowest when the split line and the maximum radial load point are apart from each other by 90°.

In addition, the retainer 24 may be a metal retainer manufactured by pressing or cutting a metal material or a resin retainer manufactured by injection molding a resin material having high elastic deformability.

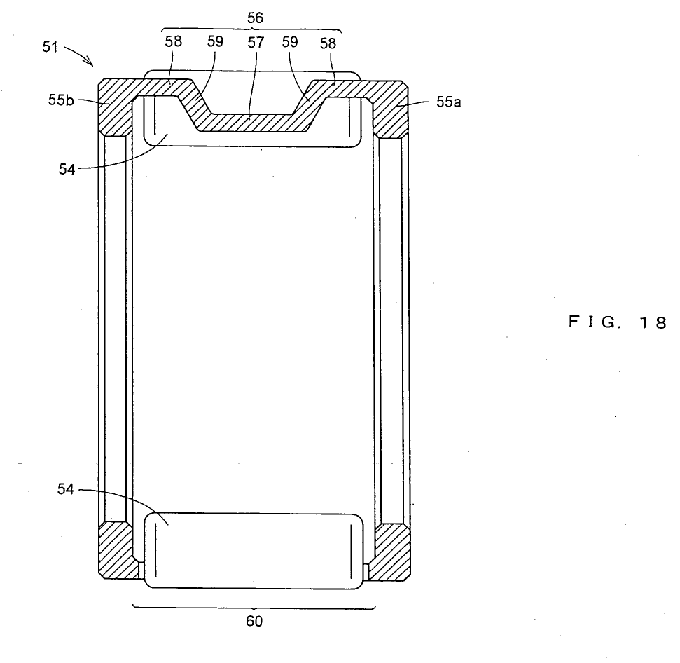

A variation of the crank shaft supporting structure shown in FIG. 1 will be described with reference to FIG. 17 hereinafter. In addition, since its basic constitution is the same as that of the crank shaft supporting structure shown in FIG. 1, the description of the same parts will be omitted and a difference point will be described.

Referring to FIG. 17, a needle roller bearing 11 for supporting a crank shaft 15 rotatably comprises an outer ring having a plurality of outer ring members 12a split by split lines extending in the axial direction of the bearing, a plurality of needle rollers 13 arranged on the track surface of the outer ring so that they can roll, a split type retainer 14 having a plurality of cut parts 14a extending in the axial direction on the circumference, and a buffer member 14d at the end surface of the cut part 14a.

Furthermore, the gap between abutting parts is filled with the buffer member 14d. The buffer member 14d may be a plate spring made of metal, a FRP such as Viton (registered mark), or a rubber member that is superior in heat resistance such as silicon rubber (RSi) and the like. It may be sandwiched when a projected part 14b and a recessed part 14c are engaged, or may have been bonded to either one or both end surfaces previously.

According to the above constitution, even when a load is applied to the needle roller bearing 11 due to the rotation of the crank shaft 15, since the corresponding cut parts 14a are not in contact with each other, a metallic sound is prevented from being generated. Furthermore, since the contact part can be prevented from being worn, the needle roller bearing 11 has a long life.

Next, an example of the needle roller bearing for supporting the crank shaft according to the above each embodiment will be described with reference to FIGS. 18 to 20. Referring to FIG. 18, a needle roller bearing 51 comprises an outer ring (not shown) split into outer ring members (not shown) by two split lines extending in the axial direction, a retainer 53 split into retainer segments 53a and 53b by two split lines extending in the axial direction similar to the outer ring, and a plurality of needle rollers 54 retained by the retainer 53 and arranged along the inner diameter surface of the outer ring. In addition, the outer ring is the split type outer ring formed by the “natural splitting” shown in FIGS. 2 to 4.

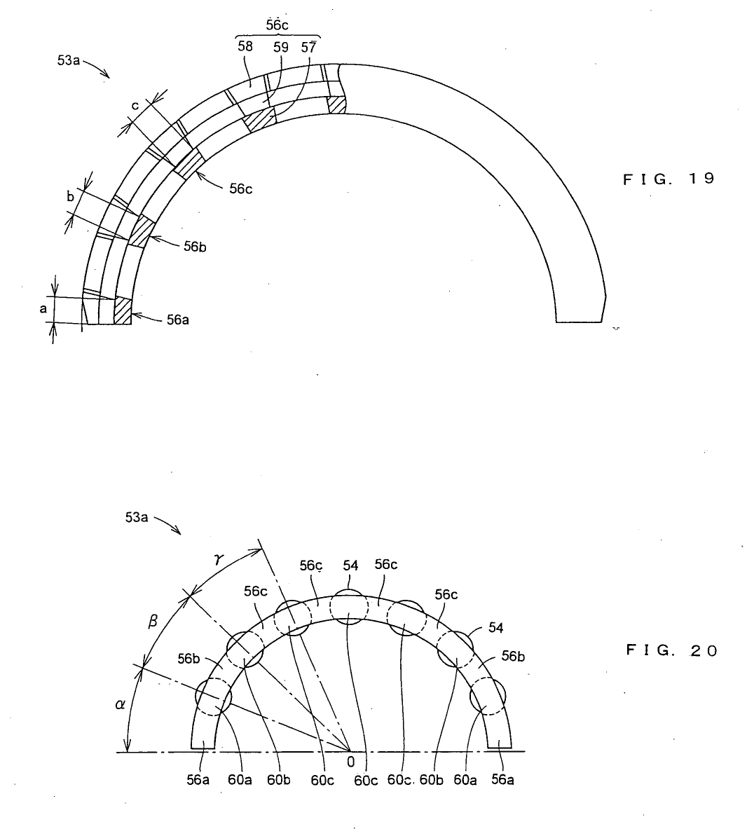

The retainer segment 53b shown in FIG. 18 will be described with reference to FIGS. 18 to 20 hereinafter. In addition, FIG. 18 is a view showing the retainer segment 53a housing the needle rollers 54, FIG. 19 is a view showing the relation of the width dimensions of the pillar parts of the retainer segment 53a in the circumferential direction, and FIG. 20 is a view showing pitches of the pockets of the retainer segment 53a. In addition, since the retainer segment 53b has the same constitution as that of the retainer segment 53a, its description will be omitted.

Referring to FIG. 18, the retainer segment comprises a pair of ring parts 55a and 55b (referred to as the “ring part 55” collectively), a plurality of pillar parts 56 projecting from end surface of the ring part 55 in the axial direction and connecting the ring parts 55a and 55b, and a plurality of pockets 60 provided at a region surrounded by the ring part 55 and adjacent pillar parts 56 to house the needle rollers 54. Each of the ring parts 55a and 55b is in the form of an arc. According to this embodiment, since the retainer 53 is split into the two retainer segments 53a and 53b, each segment is a semicircle having a central angle of 180°. In addition, the retainer segments 53a and 53b are connected in the circumferential direction to form the annular retainer 53 when incorporated in the crank shaft.

In addition, the pillar part 56 comprises a first roller stopper 57 at the center part in the axial direction to prevent the needle roller 54 from escaping inward in the diameter direction, second roller stoppers 58 at both ends in the axial direction to prevent the needle roller 54 from escaping outward in the diameter direction, and a slanting part 59 to connect the first roller stopper 57 and the second roller stoppers 58.

Referring to FIG. 19, the pillar part 56 provided in the retainer segment 53a comprises two first pillar parts 56a positioned closest to the end surfaces of the ring part in the circumferential direction, two second pillar parts 56b positioned adjacent to the first pillar parts 56a, and a plurality of third pillar parts 56c positioned between the second pillar parts 56b, and those pillar parts have the same configuration.

Here, when it is assumed that the width of the first pillar part 56a in the circumferential direction is “a”, the width of the second pillar part 56b in the circumferential direction is “b”, the width of the third pillar part 56c in the circumferential direction is “c” among the pillar parts 56, they are set so as to satisfy the relation c<a≦b. Here, according to the width of the pillar part 56 in the circumferential direction, the width of the second roller stopper 58 is the largest and the widths of the first roller stopper 57 and the slanting part 59 become smaller in this order. In addition, each dimension of the parts 57, 58 and 59 is increased from the inner side in the diameter direction to the outer side in the diameter direction. However, when the corresponding parts of each of the pillar parts 56a, 56b and 56c are compared, the above relation is to be surely satisfied.

According to the above constitution, when the width of the second pillar part 56b in the circumferential direction is set larger than the widths of the other pillar parts 56a and 56c in the circumferential direction, the strength of the second pillar part 56b in which the highest load is applied at the time of the rotation of the bearing can be increased. Here, although it is also considered that the strength of the whole retainer segment 53a is increased by setting the widths of all the pillar parts 56 in the circumferential direction to the same as that of the second pillar part 56b, when the widths of the pillar parts 56 in the circumferential direction is increased, the number of needle rollers that can be housed is decreased or the roller diameter has to be decreased to maintain the number of the needle rollers, which is not appropriate because the load capacity of the needle roller bearing 51 is lowered. Therefore, as described above, it is preferable that the widths of the pillar parts in the circumferential direction are set according to the load applied to each of the pillar parts 56a, 56b and 56c.

Referring to FIG. 20, the pockets 60 provided in the retainer segment 53a comprise two first pockets 60a provided between the first pillar part 56a and the second pillar part 56b, two second pockets 60b provided between the second pillar part 56b and the third pillar part 56c adjacent to the second pillar part 56b, and a plurality of third pockets 60c provided between the adjacent third pillar parts 56c. In addition, this embodiment shows an example in which the number of the third pillar parts 56c is three and the number of the third pockets 63c is three. In addition, the pockets 60a, 60b and 60c have the same configuration and size to house the needle rollers 54 having the same configuration and size.

Here, since the widths of the pillar parts 56a, 56b and 56c in the circumferential direction are different from each other and the widths of the pockets 60a, 60b and 60c in the circumferential direction are the same, the pitches of the pockets 60a, 60b and 60c are irregular. That is, when it is assumed that the central angle between the end surface of the retainer segment 53a in the circumferential direction and the first pocket 60a is “α”, the central angle between the first pocket 60a and the second pocket 60b is “β” and the central angle between the second pocket 60b and the third pocket 60c adjacent to the second pocket 60b is “γ”, the relations that α≠β, β≠γ, and γ≠α are satisfied. In addition, these relations are applied to the pitches on the right side in the drawing. In addition, the central angle between the adjacent third pockets 60c is the same as “γ”.

According to this embodiment, since the dimensions of the pillar parts 56a, 56b and 56c in the circumferential direction are such that c<a≦b, the central angles are such that γ<α≦β. In addition, the “central angle” in this specification means the angle formed between lines connecting the rotation center “O” of the bearing and the end of the retainer segment 53a in the circumferential direction or the rotation centers of the needle rollers 54 housed in the pockets 60a, 60b and 60c.

The retainer segment 53a having the above constitution is formed by pressing or cutting nickel-chrome-molybdenum steel (SMCM) or chrome-molybdenum steel (SCM) used as a starting material. Furthermore, in order to obtain predetermined strength and other mechanical properties, a carburizing treatment or a carbonitriding treatment is performed.

In addition, although the widths of the first to third pillar parts 56a, 56b and 56c in the circumferential direction are set so as to satisfy c<a≦b in the above embodiment, a some degree of effect can be expected when the width “b” of the second pillar part 56b in the circumferential direction is set so as to be larger than the widths “a” and “c” of the other pillar parts 56a and 56c in the circumferential direction, and the width “a” of the first pillar part 56a and the width “c” of the third pillar part 56c are set to the same value.

In addition, although the number of the third pillar parts 56c is three and the number of the third pockets 60c is three in the above embodiment, the present invention is not limited to this. The above number may be any number. The number of the third pockets 60c is determined by the widths of the pillar parts 56a, 56b and 56c in the circumferential direction and the roller diameter of the needle roller 54, for example.

Furthermore, although the needle roller bearing 51 comprises the outer ring and the retainer 53 and the needle rollers 54 in the above embodiment, the present invention may be applied to a cage and roller comprising a retainer and needle rollers without an outer ring.

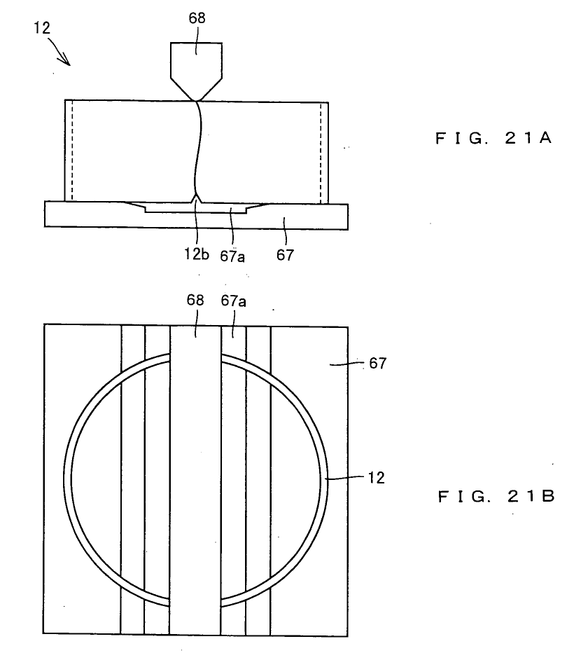

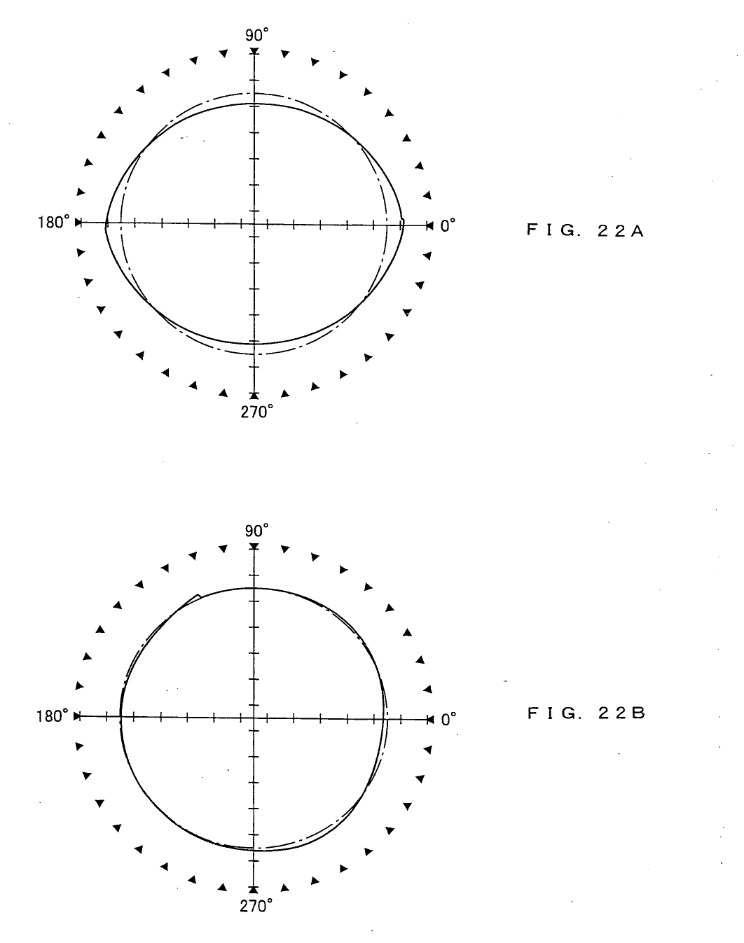

A method of splitting the outer ring 12 of the needle roller bearing by the natural splitting will be described with reference to FIGS. 21A and 21B.

First, as shown in FIG. 21A, two V-shaped grooves 12b serving as notches extending in the diameter direction are formed at one end surface of a cylindrical material to become the outer ring 12 in the axial direction at a first step. Then, the cylindrical material is set on a table 67 with the V-shaped groove 12b side down at a second step. This table 67 has a groove 67a in the center, so that a space is provided in the vicinity of the V-shaped groove 12b. In addition, FIG. 21B is a plan view of FIG. 21A.

At a third step, a load is applied to the end surface in which the V-shaped groove 12b is not formed in the direction crossing the end surface by a tool 68. Thus, stress is concentrated at a root part of the V-shaped groove 12b and the outer ring 12 is split from this part as a starting point.

According to the above splitting method, since a load is not applied to the outer ring 12 in the diameter direction, the vicinity of the split part of the outer ring 12 is not largely deformed inward in the diameter direction as shown in FIG. 22A. When the outer ring 12 is incorporated into the crank shaft 15 and the like, high roundness can be maintained as shown in FIG. 22B. As a result, since the rolling space can be kept constant in the circumferential direction of the bearing, the needle roller 13 can stably rolls, so that a noise or oscillation can be prevented from being generated or a trouble such as flaking or seizing due to the lack of an oil film and the like can be prevented from being generated.

In addition, although the above outer ring 12 is split into the two outer ring members 12b by forming the two V-shaped grooves 12b at one end surface in the axial direction in the above example, the V-shaped grooves may be provided three positions or more to split the outer ring 12 into three outer ring members 12a or more.

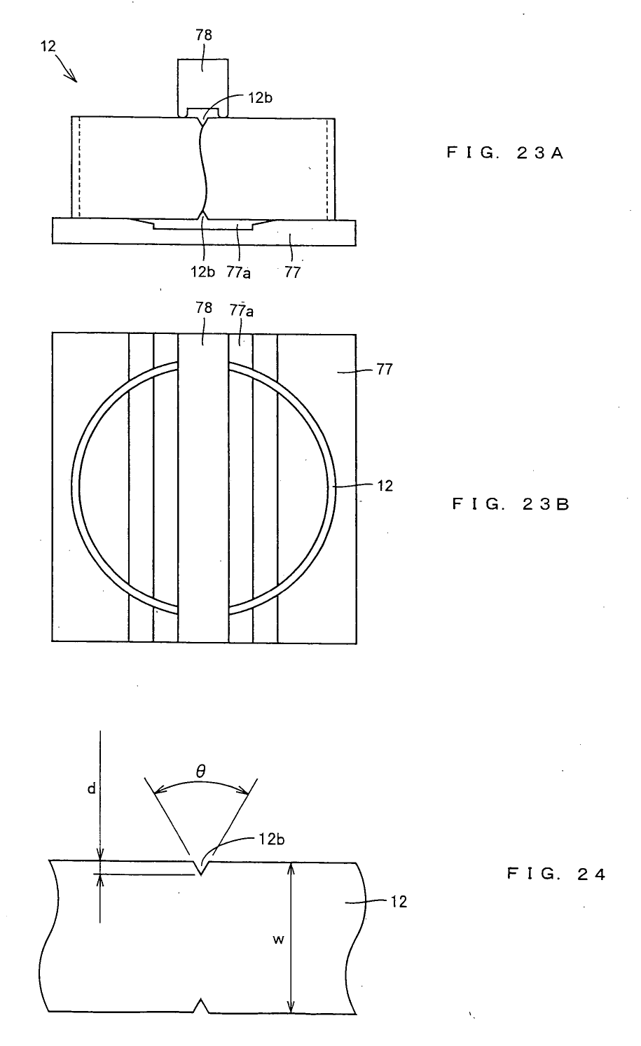

In addition, according to another embodiment of the natural splitting, as shown in FIGS. 23A and 23b, V-shaped grooves 12b are formed at both end surfaces of a cylindrical material to become the outer ring 12 in the axial direction as notches extending in the diameter direction at a first step. At a second step, the outer ring 12 is put on a table 77 so that a space is provided in the vicinity of one V-shaped groove 12b. At a third step, a load is applied to the direction crossing the end surface by a tool 78 positioned so as not to be in contact with the other V-shaped groove 12b provided in the other end surface to split the outer ring 12.

The configuration of the V-shaped groove in the above embodiments will be described with reference to FIG. 24 hereinafter.

First, the angle θ of the V-shaped groove 12b is set within a range 5°≦θ≦150°. In order to generate stress concentration at the root part of the V-shaped groove 12b, the angle θ may be as small as possible. However, when the angle θ is too small, it is difficult to form the V-shaped groove 12b. Hence, it is desirable that the angle may be set within the above range in view of split processability of the outer ring 12 and processability of the V-shaped groove 12b.

In addition, when it is assumed that the width of the outer ring 12 in the axial direction is “w”, the depth of the V-shaped groove 12b is set within a range of d/w≦0.2. Because, when the depth of the V-shaped groove is large beyond necessity, the needle roller 13 rolls unstably when passes over the V-shape groove 12.

Furthermore, when the present invention is applied to an outer ring 12 having a thickness “t” of 5 mm or less, a higher effect can be expected. When the outer ring 12 is split by the conventional method, as the thickness “t” becomes small, the vicinity of the split part is largely deformed.

Although the outer ring 12 comprises the two outer ring members 12a in the above embodiment, the present invention is not limited to this. For example, three or more outer ring members may be combined. In addition, although both outer ring members 12a are in the form of the semicircle having the central angle of 180° and have the same configuration in the above embodiment, their central angles may be different from each other. Furthermore, the above may be applied to the case where the retainer is split into the retainer segments.

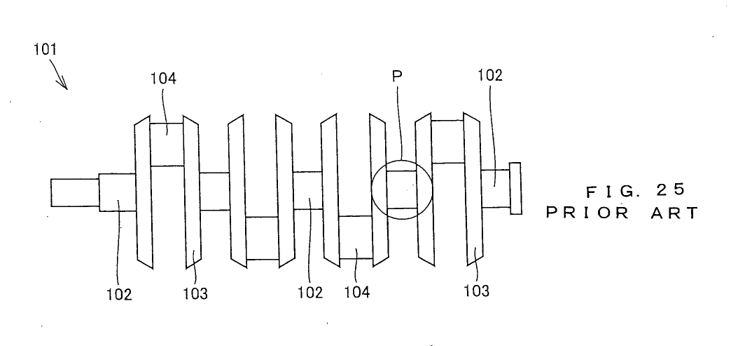

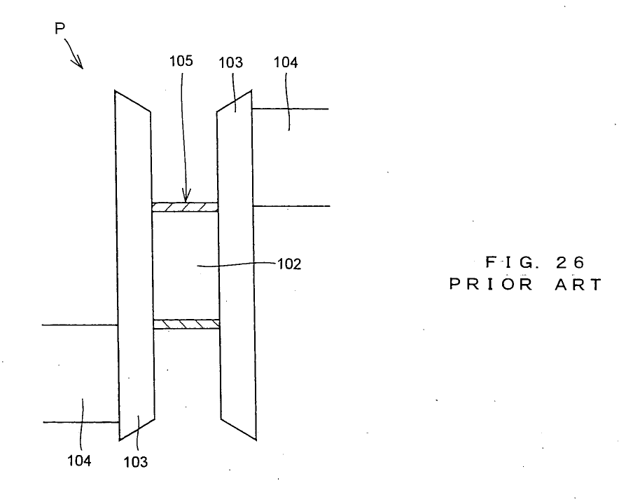

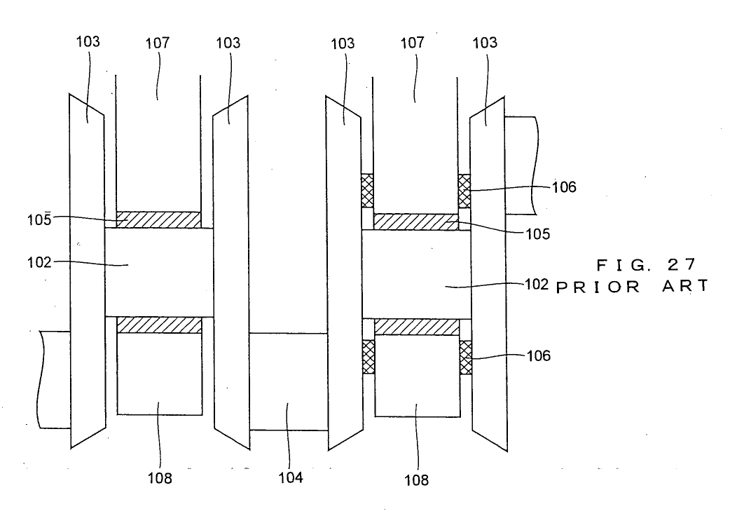

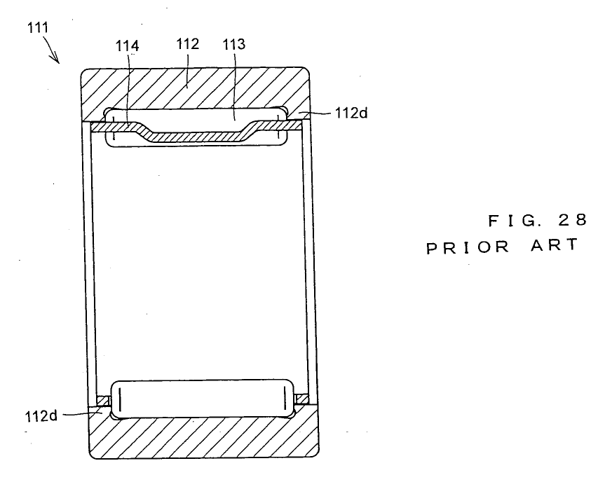

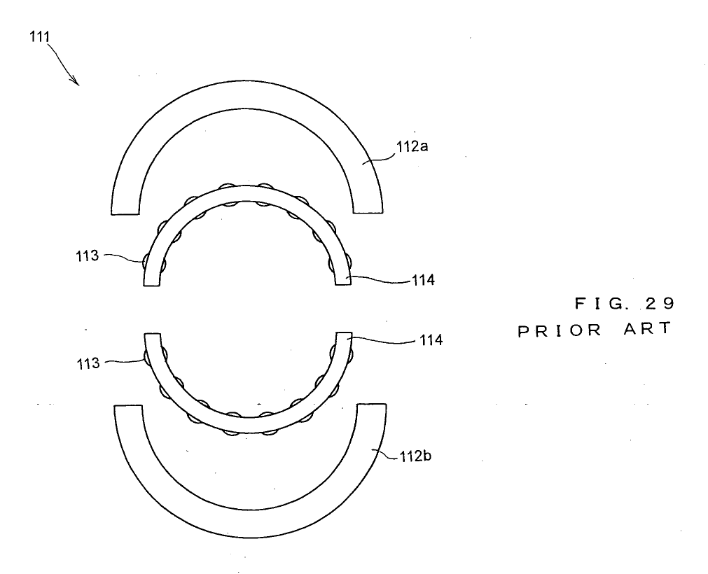

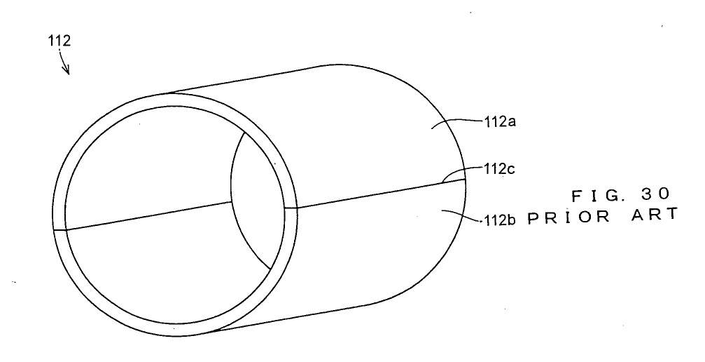

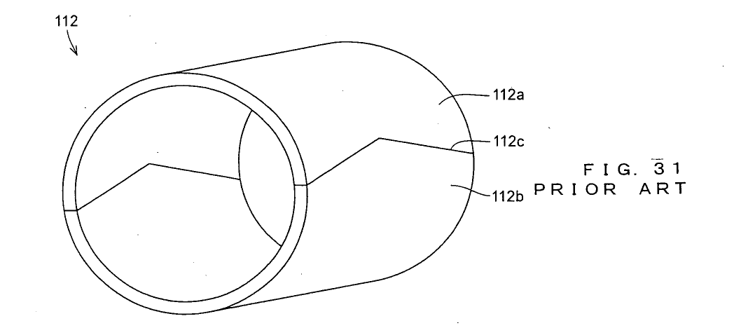

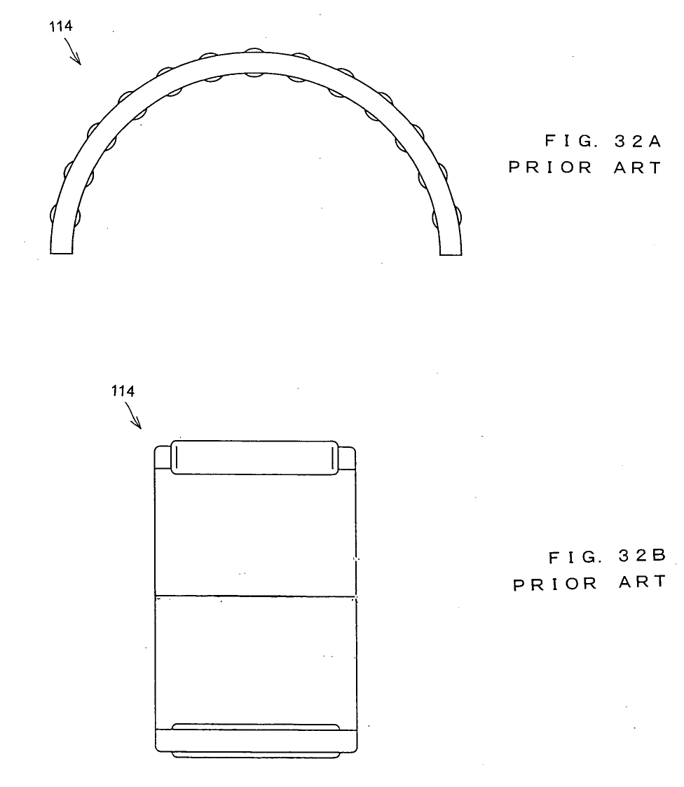

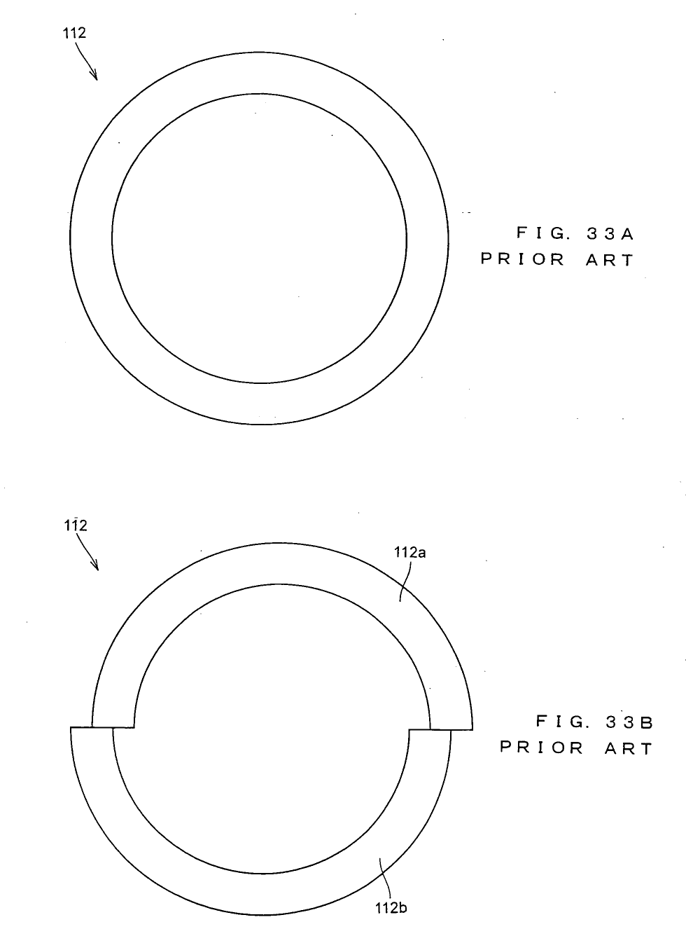

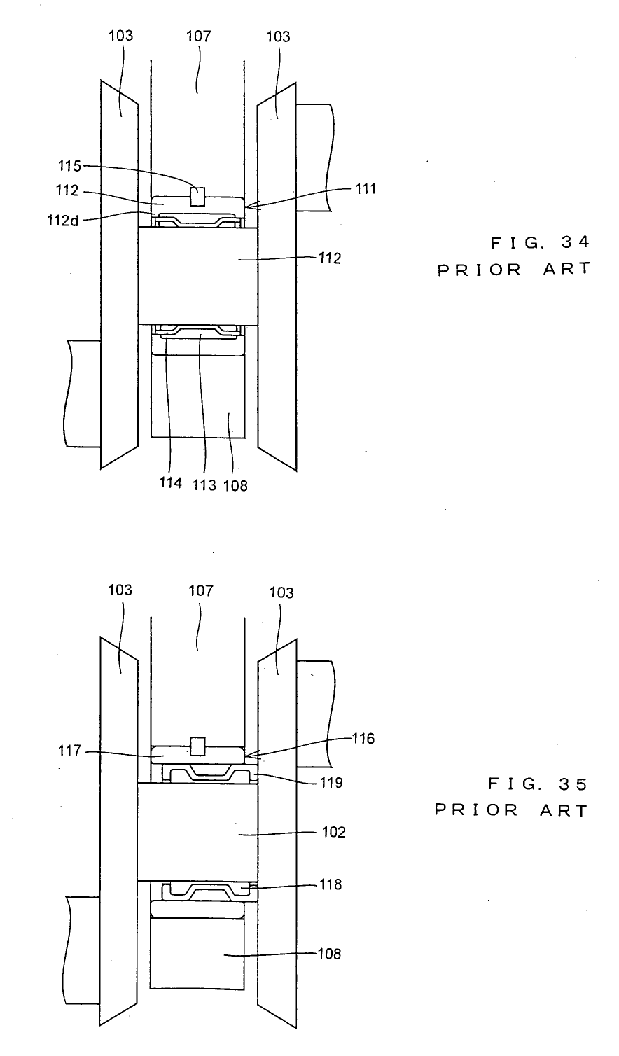

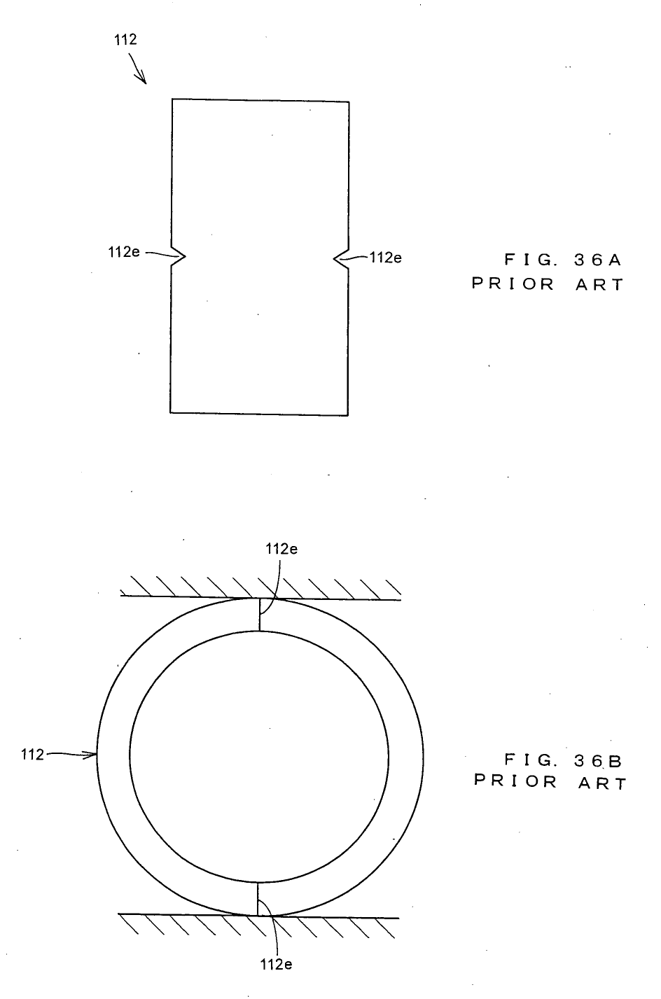

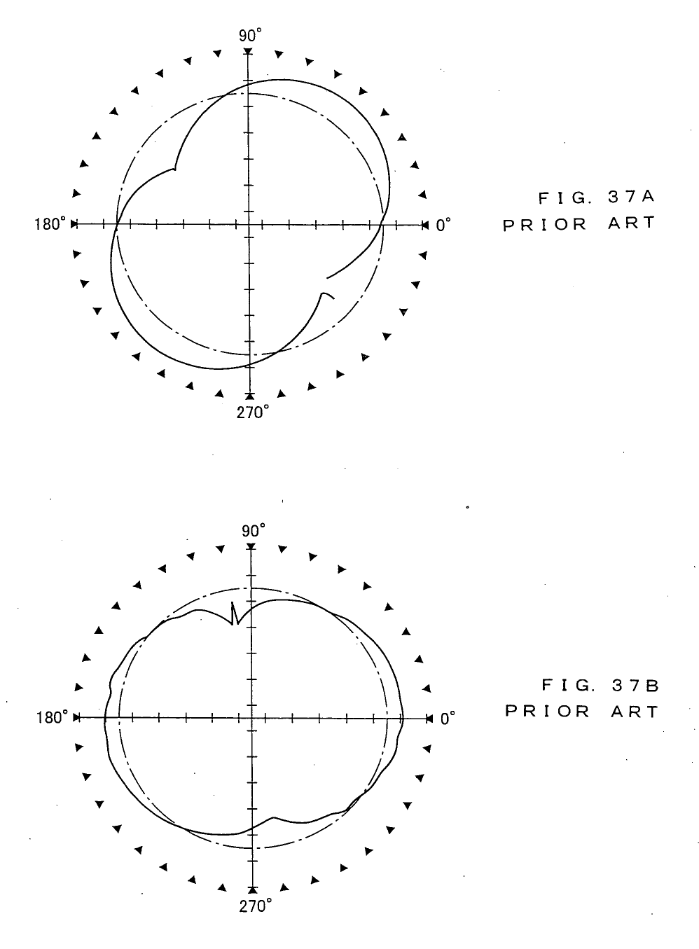

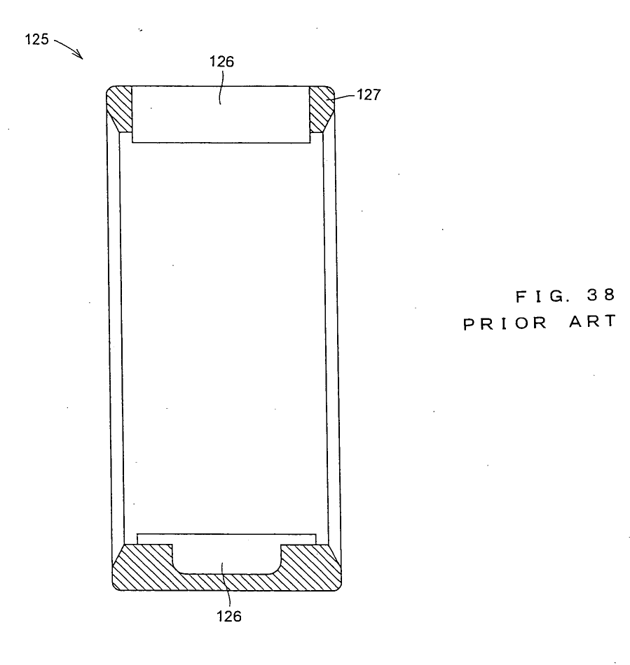

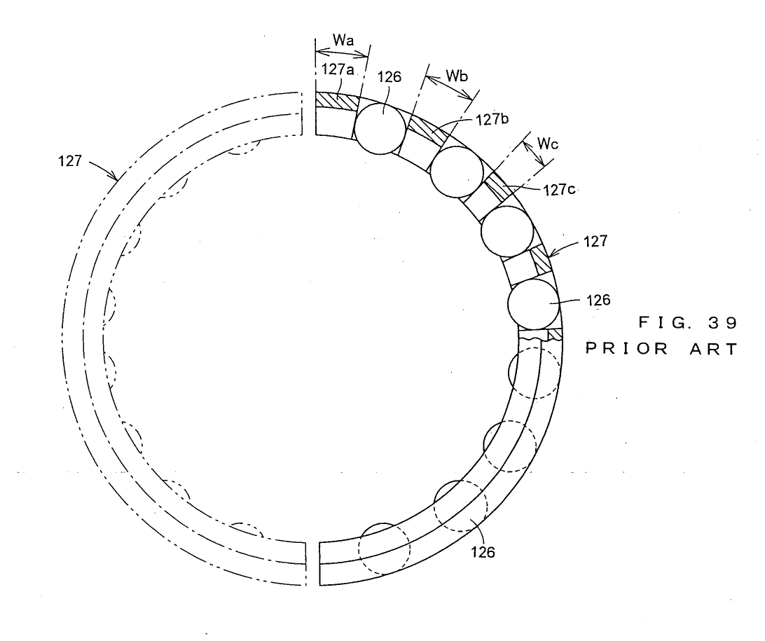

In addition, the crank shaft supporting structure according to the present invention can be applied to a crank shaft of an engine of a car or a two-wheel vehicle. In addition, although the number of cylinders may be one or more, when the present invention is applied to the crank shaft used in a multiple cylindered engine having a shaft sandwiched between the crank arms as shown in the part “P” in FIG. 25, a higher effect can be expected.

Furthermore, according to the present invention, when the above characteristic parts in the above embodiments are arbitrarily combined, a synergetic effect can be expected.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

The present invention can be advantageously applied to the needle roller bearing for supporting the crank shaft of the engine.

What is claimed is:

1. A needle roller bearing comprising:
an outer ring having a plurality of outer ring members split by split lines extending in the axial direction of the bearing; and
a plurality of needle rollers arranged on the track surface of said outer ring so that they can roll, wherein
a load is applied to the end surface of said outer ring in the direction crossing the end surface to split said outer ring.

2. The needle roller bearing according to claim 1, wherein
said outer ring has a V-shaped groove having a V-shaped sectional configuration at its end surface,
the angle θ of said V-shaped groove is within a range of 5°≦θ≦150°, and
the width “w” of said outer ring in the axial direction and the depth “d” of said V-shaped groove has a relation d/w≦0.2.

3. The needle roller bearing according to claim 1, wherein the thickness “t” of said outer ring is t≦5 mm.

4. The needle roller bearing according to claim 1, wherein said needle roller bearing further comprises:
a retainer having a cut part extending in the axial direction on the circumference; and
a buffer member at the end surface of said cut part.

5. A crank shaft supporting structure comprising:
a crank shaft having a shaft and crank arms positioned at both ends of said shaft; and
the needle roller bearing for supporting said crank shaft rotatably as set forth in claim 1, wherein
said needle roller bearing further comprises a retainer whose both ends project from the end surface of said outer ring to be in contact with said crank arms.

6. A crank shaft supporting structure comprising:
a crank shaft; and
the needle roller bearing for supporting said crank shaft rotatably as set forth in claim 1, wherein
said needle roller bearing further comprises an integral retainer having a cut part extending in the axial direction on the circumference.

7. A crank shaft supporting structure comprising:
a crank shaft; and
the needle roller bearing for supporting said crank shaft rotatably as set forth in claim 1, wherein
the split lines of said outer ring are provided apart from a maximum radial load point of said needle roller bearing to both sides in the circumferential direction by 50° or more.

8. The crank shaft supporting structure according to claim 7, wherein said split lines are provided apart from a symmetric position to the maximum radial load point across the bearing center to both sides in the circumferential direction by 50° or more.

9. A crank shaft supporting structure comprising:
a crank shaft; and
the needle roller bearing for supporting said crank shaft rotatably as set forth in claim 1, wherein
said needle roller bearing further comprises a retainer having cut parts extending in the axial direction on the circumference, a projected part at one cut part and a recessed part for receiving said projected part, at the other cut part, and the gap δ between said projected part and said recessed part in the axial direction is such that 0≦δ≦0.2 mm.

10. A crank shaft supporting structure comprising:
a crank shaft; and
the needle roller bearing for supporting said crank shaft rotatably as set forth in claim 1, wherein
said needle roller bearing further comprises a retainer formed by circumferentially connecting a plurality of retainer segments each having a plurality of pockets for housing said needle rollers and comprising an arc-shaped ring part and a plurality of pillar parts projecting from the end surface of said ring part in the axial direction,
said pillar part comprises two first pillar parts positioned closest to both end surfaces of said ring part in the circumferential direction, two second pillar parts adjacent to said two first pillar parts, respectively and third pillar parts arranged between said two second pillar parts, and
the width of said second pillar part in the circumferential direction is larger than that of the other pillar parts.

11. The crank shaft supporting structure according to claim 10, wherein
when it is assumed that the width of said first pillar part in the circumferential direction is “a”, the width of said second pillar part in the circumferential direction is “b”, and the width of said third pillar part in the circumferential direction is “c”, a relation such that c<a≦b is satisfied.

12. The crank shaft supporting structure according to claim 10, wherein said retainer segment comprises:
a first pocket formed between said first pillar part and said second pillar part,
a second pocket formed between said second pillar part and said third pillar part adjacent to said second pillar part, and
a third pockets formed between said adjacent third pillar parts, and
when it is assumed that the central angle formed between the end surface of said ring part in the circumferential direction and the first pocket is “α”, the central angle formed between said first pocket and said second pocket is “β” and the central angle formed between said second pocket and said third pocket, adjacent to said second pocket is “γ”, the relations such that α≠β, β≠γ, and γ≠α are satisfied.

13. The crank shaft supporting structure according to claim 10, wherein said needle roller bearing further comprises an outer ring in which an annular member is formed by a cutting process and a plurality of split lines extending in the axial direction on the circumference of said annular member are formed by natural splitting.

14. The crank shaft supporting structure according to claim 10, wherein
said retainer segment comprises SNCM or SCM as a starting material and formed through a carburizing or carbonitriding treatment.

15. The crank shaft supporting structure according to claim 6, wherein said retainer is formed of a resin material.

16. The crank shaft supporting structure according to claim 6, wherein said crank shaft is used in a multiple cylindered engine.

17. A method of splitting an outer ring of a needle roller bearing comprising the outer ring having a plurality of outer ring members split by split lines extending in the axial direction of the bearing, and a plurality of needle rollers arranged on the track surface of said outer ring so that they can roll, comprising a step of splitting a cylindrical material by applying a load to the end surface of the cylindrical material in the direction crossing the end surface to split the outer ring.

18. The method of splitting the outer ring according to claim 17, comprising:
a step of forming a notch extending in the diameter direction, on one end surface of said cylindrical material in the axial direction,
a step of setting said outer ring such that the end surface having the said notch side is provided downside and a space is provided in the vicinity of said notch, and
a step of splitting said cylindrical material by applying the load to the other end surface not having said notch.

19. The method of splitting the outer ring of the needle roller bearing according to claim 17, comprising:
a step of forming notches extending in the diameter direction, on both end surfaces of said cylindrical material in the axial direction,
a step of setting said outer ring such that the one end surface is arranged on the lower side and a space is provided in the vicinity of said notch, and
a step of splitting said cylindrical material by applying the load to the other end surface except for said notch.
